(19) United States
(12) Patent Application Publication
(10) Pub. No.: US 2006/0233501 A1
(43) Pub. Date: Oct. 19, 2006

(54) Ultraviolet curing

(76) Inventor: Clayton Sampson, Upper Hepford (GB)

Correspondence Address: JOEL D. SKINNER, JR.;SKINNER AND ASSOCIATES, 212 COMMERCIAL ST., HUDSON, WI, 54016, US

(21) Appl. No.: 10/548,281

(22) PCT Filed: Feb. 27, 2004
(86) PCT No.: PCT/GB04/00801

§ 371 Date: Jan. 25, 2006

(30) Foreign Application Priority Data
Mar. 1, 2003 (GB) 0304761.0

(51) Int. Cl. G02B 6/04

(52) U.S. Cl. 385/115

(57) ABSTRACT

A curing apparatus comprises a plurality of light emitting areas each being operable to emit ultraviolet radiation. In one embodiment, each area is made up of one or more ultraviolet light emitting diodes.

This invention relates to the curing of inks, adhesives or coatings using ultraviolet light, and in particular to an apparatus and method for use in such curing.

It is known to use ultraviolet light to assist in the curing of, for example, inks applied to a printing medium by, for example, an inkjet technique. Typically such curing has been achieved using a mercury arc lamp as an ultraviolet light source. However, the use of such a light source has a number of disadvantages. For example, a mercury arc lamp often produces a significant infra-red output in addition to the desired ultraviolet wavelengths, and is therefore of poor thermal efficiency. Further, the spectral output varies significantly over the working life of the lamp, and the working life of the lamp is relatively short. Additionally, the shape and size of such a lamp can result in difficulties accommodating the lamp within a printer or the like, particularly if a cooling mechanism is also required to disperse heat generated by the lamp, in use. A further disadvantage is that such a lamp takes some time to warm up to an operating temperature at which the desired output is achieved, and after use takes some time to cool down before it can be switched back on, and therefore is not suitable for rapid switching.

It is an object of the invention to provide an apparatus and method of use thereof in which these disadvantages are of reduced effect.

According to one aspect of the invention there is provided an ultraviolet curing apparatus comprising a plurality of light emitting areas operable to emit ultraviolet light. Each light emitting area may comprise one or more light emitting diodes (LEDs). The LEDs used may be organic LEDs (OLEDs).

LEDs which are operable to emit ultraviolet light (UV LEDs) are advantageous in that they have a narrow spectral output band, and so are of relatively good thermal and electrical efficiency, and produce only relatively low levels of heat. They further are of good stability, having a constant output throughout their working life. The working life of a UV LED is typically many times longer than a conventional UV source.

If desired, the plurality of UV LEDs may include at least a first type of LED operable to emit UV radiation of a first wavelength and a second type of LED operable to emit UV radiation of a second, different wavelength. The provision of LEDs having two or more output wavelengths may be beneficial to the process of curing inks, adhesives, coatings or the like. For example, some LEDs may be arranged to emit UVA wavelengths and other to emit UVC wavelengths.

The LEDs conveniently form an array, individual LEDs and/or groups of LEDs being controllable independently of other individual LEDs and/or groups of LEDs. By providing such an arrangement of LEDs, an apparatus can be provided which can be operated in such a manner as to emit UV radiation primarily to a chosen target area, for example to an area to which ink has been applied, or to permit control over the intensity of the radiation applied.

A control arrangement may be provided to allow control over the power output of the LEDs.

Although the light emitting areas may be made up of LEDs or OLEDs, other systems are possible. For example, other electronic light emitting devices may be used. By way of example, each light emitting area may comprise a part of a plasma screen, plasma based emitting system, or the like.

According to another aspect of the invention there is provided a delivery and curing apparatus for use in the delivery and curing of a curable material comprising a delivery head controllable to deliver a quantity of curable material, and a device having a plurality of areas operable to emit UV radiation to at least partially cure the material delivered by the delivery head. The device preferably, includes a plurality of UV LEDs, each area including one or more of the LEDs. However, other electronic light emitting elements may be used, for example each area may comprise part of a plasma screen.

The delivery head may comprise part of an inkjet printer, for example of the drop on demand (DOD) type, but it will be appreciated that it could be part of an alternative inkjet printer, an alternative type of printer, or indeed form part of a delivery system for an alternative curable material, for example suitable adhesives or coatings.

The plurality of UV LEDs may have any of the characteristics and/or functions mentioned hereinbefore.

The invention further relates to a method of curing a curable material comprising controlling the operation of an array of UV LEDs to emit ultraviolet radiation to a predetermined target area, and/or controlling the operation of an array of UV LEDs to control the intensity of ultraviolet radiation incident upon a target area.

The invention will further be described, by way of example, with reference to the accompanying drawings, in which:

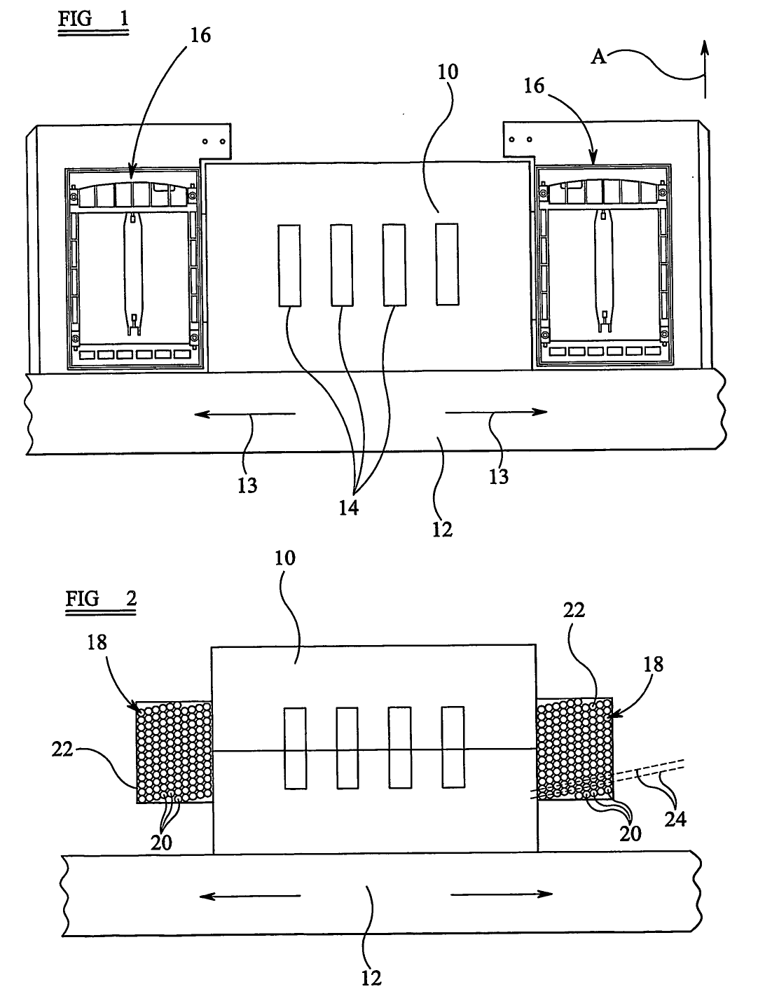

FIG. 1 is a diagrammatic view illustrating a known curing apparatus;

FIG. 2 is a view similar to FIG. 1 but illustrating a curing apparatus in accordance with an embodiment of the invention;

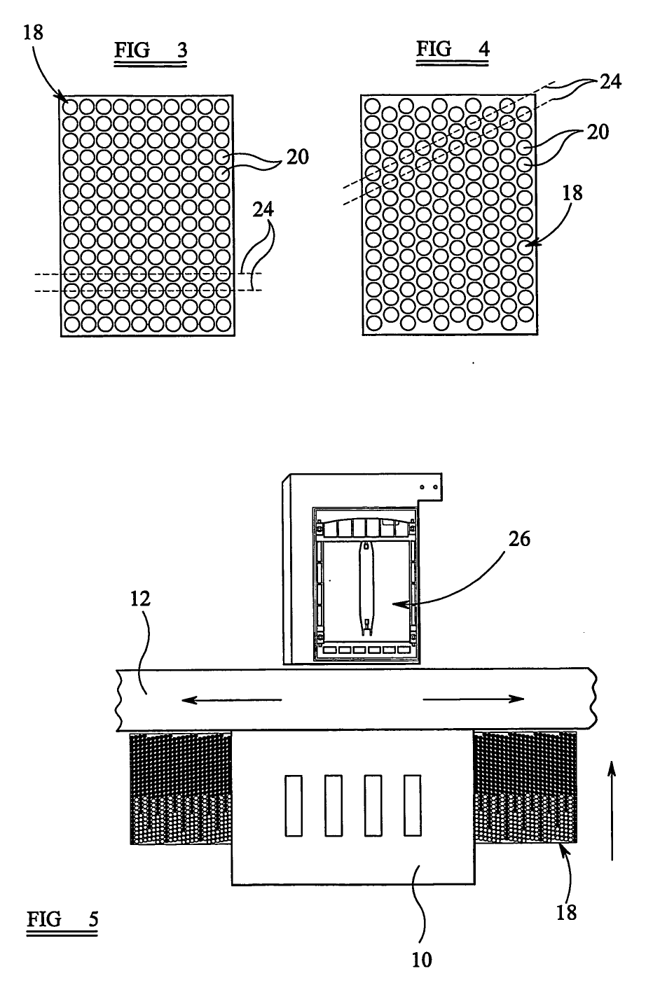

FIGS. 3 and 4 illustrate alternatives to part of the apparatus illustrated in FIG. 2;

FIGS. 5 to 7 are views similar to FIG. 2 illustrating further alternatives;

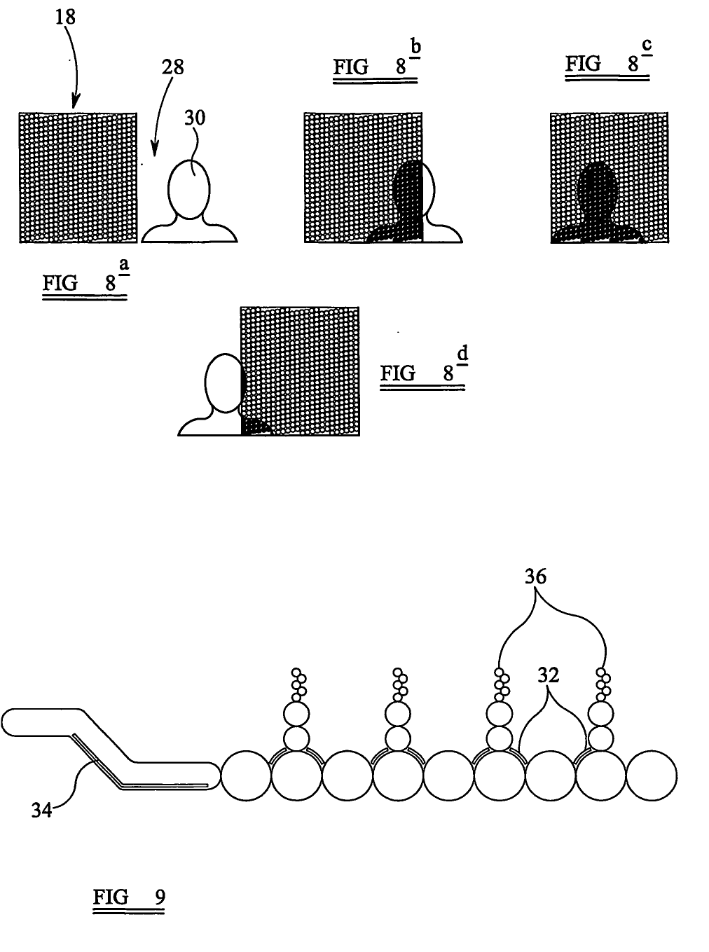

FIGS. 8a to 8d illustrate a control technique for use with the apparatuses shown in FIGS. 2 to 7; and

FIG. 9 illustrates the use of the invention with another printing technique.

Referring firstly to FIG. 1 there is shown part of an inkjet printer of the drop on demand (DOD) type. The printer includes a print head 10 which is translatable across a medium to which ink is to be applied by moving the print head 10 along abeam 12 in the direction of arrows 13. As shown, the printhead 10 has a number of ink delivery outlets 14. Movement of the print head 10 along the beam 12, and the delivery of ink from the outlets 14 is controlled in an appropriate manner to deliver a suitable quantity of ink to a chosen location or locations on the medium. Depending upon the type of printer, either the medium is moved, in steps, in direction A by an appropriate drive device, or the beam 12 is moved, in steps, in a direction transverse to its longitudinal axis.

As shown in FIG. 1, a pair of UV sources 16 are provided, the sources 16 comprising mercury arc lamps. The sources 16 are positioned on opposing sides of the print head 10 and are moveable with the print head 10 to irradiate ink delivered by the print head with ultraviolet light to assist in curing thereof.

In use, a substrate or medium to which ink is to be delivered is positioned beneath the outlets 14. The medium or the beam 12 is moved, in steps, as mentioned hereinbefore, and the print head 10 is moved back and forth along the beam 12 to allow the delivery of ink in the desired locations upon the medium. The sources 16 are intended to be operated throughout the delivery operation to irradiate and assist in the curing of the ink dispensed by the print head 10.

As discussed hereinbefore, the use of a source 16 of this type in an inkjet printer has a number of disadvantages. As mentioned hereinbefore, such source 16 often has a limited life, generates excessive heat, and is unsuitable for rapid switching on and off. In the arrangement shown in FIG. 1, the print head 10 may be used to deliver ink whilst travelling in either direction along the beam 12. As a result, two sources 16 are required to allow curing of the ink immediately after it has been dispensed. However, this may mean that one of the sources 16 is redundant at any given time. Further, depending upon the mode of operation of the printer, the print head 10 may pass along the beam 12 several times before the medium is moved relative to the beam 12 by a distance sufficient to result in the ink delivered by the print head 10 being located outside of the area irradiated by the sources 16. As a result, ink delivered during one of the early passes of the print head 10 may be over-cured by the time it has left the area irradiated by the sources, whereas ink delivered during a later pass may only be partially cured. Clearly, this is undesirable. Further, where the printed image covers only part of the medium, the medium is exposed to the UV radiation and this may degrade the medium, or light reflected from the medium may be incident upon and cause damage to the print head.

FIG. 2 illustrates an arrangement in accordance with an embodiment of the invention. As with the arrangement illustrated in FIG. 1, the printer shown in FIG. 2 is an inkjet printer which comprises a print head 10 translatable along a beam 12 over a medium to which ink is to be delivered, either the beam or the medium being movable in a direction perpendicular to the longitudinal axis of the beam 12. A pair of housings 22 carrying arrays 18 of light emitting diodes (LEDs) 20 arranged to emit ultraviolet light of wavelength in the range 200-380 nm are provided. The housings 22 are provided on opposing sides of the print head 10 in the direction of movement of the head 10 relative to the beam 12. Operation of the printer may be generally the same as described hereinbefore with reference to FIG. 1.

The use of UV LEDs has a number of advantages over the use of UV sources, for example, of the mercury arc lamp type. For example, heat output is reduced, and the housings 22 can be of relatively small, compact form thereby simplifying their inclusion in a printing device. Further, the working life of an LED is typically significantly longer than that of a mercury arc lamp, thus maintenance and replacement can be performed less frequently.

The use of arrays 18 of UV LEDs has further advantages over the use of other UV sources. For example, the arrays 18 may be switched on and off rapidly, when desired, without requiring a lengthy warm-up or cool down period. It is therefore possible to operate the printer with only the trailing one of the arrays 18 operating at any given time, if desired. The arrays 18 can also be switched off when over parts of the medium to which ink has not been applied, thereby reducing the risk of degradation.

In the arrangement shown in FIG. 2, the LEDs 20 of each array 18 are arranged in rows 24 which are angled slightly from the direction of movement of the print head 12 along the beam 10. Such angling of the rows 24 of LEDs 20 results in the intensity of the UV radiation incident upon the medium being of good uniformity.

The arrangement of the LEDs 20 need not be in the pattern shown in FIG. 2, and FIGS. 3 and 4 illustrate two possible alternative layouts. In the arrangement shown in FIG. 3, the rows 24 of LEDs 20 are parallel to the direction of movement of the printhead 12 along the beam 10. FIG. 4 illustrates an arrangement in which the rows 24 are angled by an increased amount to the direction of movement of the print head 12 relative to the beam 10. It will be appreciated that a number of other arrangements are possible.

Depending upon the application in which the invention is used, it may be desirable to irradiate the ink with radiation of two or more distinct ultraviolet wavelengths or wavelength bands, for example UVA and UVC radiation, as different inks may respond differently to given wavelengths, and the different wavelengths penetrate to different depths within the ink droplets. This may be achieved by including in each array 18 at least two different types of UV LED, one type being arranged to emit radiation of one wavelength or wavelength band, for example UVA, and another type being arranged to emit radiation of a second wavelength or wavelength band, for example UVC.

Depending upon the application in which the invention is used, it may be desirable to partially cure the ink immediately after delivery from the print head 12, and to perform a final curing operation at a subsequent time. Such an arrangement may be beneficial in that, for example, when colour printing, running mixing of ink droplets of different colours may be inhibited, whilst the adhesion of subsequent layers of the ink droplets to those already dispensed is not impaired. Further, it is thought that enhanced gloss levels may be achieved as the surface of the ink has an opportunity to level or smooth itself out prior to final curing. FIG. 5 illustrates an arrangement permitting such operation. The arrangement of FIG. 5 is similar to that of FIG. 2 but includes an additional relatively high power UV source 26 carried by and moveable along the beam 12 with the print head 10. In the FIG. 5 embodiment, the additional UV source 26 is a mercury arc lamp. However, it will be appreciated that this need not be the case, and that the UV source 26 could take the form of, for example, another array of UV LEDs, or another UV light source.

In use, the arrays 18 of UV LEDs 20, which in this case are relatively low power output LEDs, are used to partially cure the ink delivered by the print head 10 in the manner described hereinbefore, but by applying a reduced intensity of radiation thereto or irradiating the ink for a shorter time period. The ink may be delivered over several passes of the print head 10 as mentioned hereinbefore, and in order to avoid over curing of the ink applied during the earlier ones of the passes, the LEDs 20 of the array 18 are controlled such that only a few of the LEDs 20 making up the first few rows 24, in the direction of relative movement of the medium, are illuminated, a greater proportion of the LEDs 20 making up subsequent rows 24 of the array 18 being switched on. Again, if desired, only the trailing one of the arrays 18 may be used at any given time. After completion of delivery of the ink, the medium passes beneath the additional source 26, the radiation from which completes the curing process.

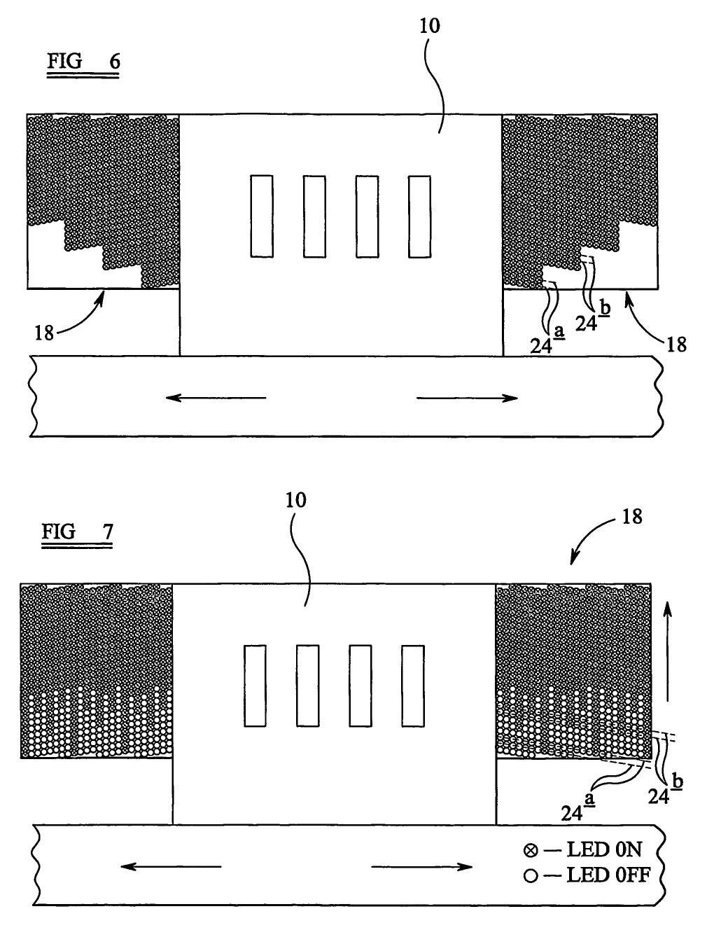

The arrangement shown in FIG. 6 illustrates a modification to the layout of the LEDs 20 of the arrays 18 to prevent over curing of ink delivered in a printing process involving several passes of the print head 10 over the medium. The arrangement of FIG. 6 is intended to fully cure the ink and so no additional UV source 26 is provided. However, the layout of LEDs 20 shown in FIG. 6 could be applied to the arrangement shown in FIG. 5. In the arrangement shown in FIG. 6, with all of the LEDs 20 of each array 18 switched on, ink delivered during a first pass of the print head 10 is subject to radiation of a relatively low intensity as a first few rows 24a of LEDs 20 in each array 18 contain only a small number of LEDs 20, subsequent rows 24b including more LEDs, and therefore being capable of providing a greater intensity of UV radiation. The arrangement illustrated in FIG. 6 is intended for use in a system in which ink delivery takes place over four passes. However, the layout may easily be modified for use in other systems in which ink is laid down over greater or fewer passes.

FIG. 7 illustrates a technique whereby the effect produced using the arrangement of FIG. 6 can be achieved by controlling the operation of the LEDs so that only a few of the LEDs in the early rows 24a are switched on, a greater proportion of those provided in later rows 24b being switched on, rather than simply altering the number of LEDs in the various rows as shown in FIG. 6. Again, as shown the arrangement is intended for use in a system in which ink is laid down over four passes, but by appropriate control over the individual LEDs, the arrays may be controlled so as to be suitable for use in a system in which ink is laid down over greater or fewer passes.

FIGS. 8a to 8d illustrate a technique in which the LEDs of an array are controlled so as to irradiate only or primarily a target area of the medium, for example an area thereof to which ink has just been applied. FIG. 8a illustrates the medium 28 onto an area 30 of which ink has been applied by a print head (not shown) prior to movement of the array 18 over the area 30. FIG. 8b illustrates the situation shortly after that shown in FIG. 8a In FIG. 8b, the array 18 has been moved over part of the area 30, and those ones of the LEDs 20 of the array 18 that are immediately over part of the area 30 have been switched on to irradiate the relevant part of the area 30 with UV light. Continued movement of the array 18 relative to the medium will result in more or the whole of the area 30 being located beneath the array 18 as shown in FIG. 8c. Again, those ones of the LEDs located immediately over the area 30 are switch on. Those LEDs which are no longer over the area 30 having been switch off. FIG. 8d illustrates the situation where the array 18 has moved further and parts of the area 30 are no longer beneath the array 18.

It will be appreciated that by the use of such a control technique, only the chosen target area of the medium is irradiated by the array. As a result, over curing of ink applied to the medium can be reduced or avoided altogether. Further, irradiation of parts of the medium to which ink has not been applied can be avoided, hereby reducing the risk of degradation thereof. Further, reflection of radiation from the medium to the print head can be reduced.

In addition to controlling the operation of the arrays 18 to control radiation intensity and/or the target area, the arrays may also be controlled in such a manner as to permit control over the power output thereof.

FIG. 9 illustrates the application of the invention to an alternative printing technique. In particular, FIG. 9 shows the application of the invention to a colour offset lithographic printing process. As shown in FIG. 9, a number of arrays 32 of UV LEDs are provided between the various print stations 36 to allow curing or partial curing of the ink applied to the medium during each printing operation. A further UV source 34 is provided to permit final or complete curing at the completion of the printing operation.

The arrays 32 of LEDs may be controlled or operated using any of the techniques described hereinbefore in relation to inkjet printing to achieve the advantages described hereinbefore.

Although for the most part in the description hereinbefore is of an arrangement in which the print head and UV LEDs move over the medium, this need not be the case and the invention is equally applicable to arrangements in which the UV LEDs are fixed and the medium is moved relative thereto.

The invention is not restricted to the use of UV LEDs or OLEDs in arrays, the use of other electronic or electronically controllable light emitting elements being possible. Further, the arrays of LEDs could be replaced with, for example, plasma screens or other plasma based emitting systems having areas operable to emit UV radiation.

It will be appreciated that the control system used to control which UV emitting devices are operable at any given time may be controlled using software. For example, the software may be arranged to relate the control of the various devices to a digital raster image or the output of a RIP raster image processing system or other system suitable for use in the creation or processing of images.

The invention could, alternatively, be used in a screen printing technique to allow controlled curing of ink applied to the medium prior to the application of a subsequent layer of ink.

Although the description hereinbefore relates primarily to printing and the delivery and curing of ink, it will be understood that the invention is not limited to the delivery and curing of inks but is also applicable to, for example, the curing of appropriate adhesives or coatings. Further, although the majority of the description relates to the delivery of ink by industrial scale DOD inkjet techniques, the invention is not limited to delivery by DOD inkjet or other inkjet techniques, but rather can be used with a wide range of ink or other curable material delivery or application techniques, and is applicable both to industrial scale applications and smaller scale applications, for example inkjet printers intended for home or office use, or mobile telephone or digital photograph printers.

1. An ultraviolet curing apparatus comprising a plurality of light emitting areas operable to emit ultraviolet light.

2. An apparatus according to claim 1, wherein the light emitting areas are defined by regions of a plasma screen or plasma based emitting system.

3. An apparatus according to claim 1, wherein each light emitting area comprises one or more light emitting diodes.

4. An apparatus according to claim 3, wherein at least one of the light emitting diodes is an organic light emitting diode.

5. An apparatus according to claim 3, wherein the light emitting diodes include at least a first type of LED operable to emit UV radiation of a first wavelength and a second type of LED operable to emit UV radiation of a second, different wavelength.

6. An apparatus according to claim 3, wherein the light emitting diodes form an array, individual LEDs and/or groups of LEDs being controllable independently of other individual LEDs and/or groups of LEDs.

7. An apparatus according to claim 6, further comprising a control arrangement to allow control over the power output of the LEDs.

8. A delivery and curing apparatus for use in the delivery and curing of a curable material comprising a delivery head controllable to deliver a quantity of curable material, and a device having a plurality of areas operable to emit UV radiation to at least partially cure the material delivered by the delivery head.

9. An apparatus according to claim 8, wherein the device includes a plurality of LEDs, each said area including one or more LEDs.

10. An apparatus according to claim 8, wherein the device includes a plasma screen or plasma based emitting system.

11. An apparatus according to claim 8, wherein the delivery head comprises part of an inkjet printer.

12. A method of curing a curable material comprising controlling the operation of an array of UV LEDs to emit ultraviolet radiation to a pre-determined target area, and/or controlling the operation of an array of W LEDs to control the intensity of ultraviolet radiation incident upon a target area.

13. (canceled)
